(19) United States
(12) Patent Application Publication
(10) Pub. No.: US 2008/0141550 A1
(43) Pub. Date: Jun. 19, 2008

(54) Laundry machine

(75) Inventors: Sang Hun Bae, Changwon-si (KR); Chang Woo Son, Changwon-si (KR); Chul Jin Choi, Changwon-si (KR); Dong Hyun Kim, Changwon-si (KR); Young Bok Son, Changwon-si (KR); Heung Jae Kim, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/980,800

(22) Filed: Oct. 31, 2007

(30) Foreign Application Priority Data
Dec. 15, 2006 (KR) 10-2006-0128474

(51) Int. Cl. F26B 19/00

(52) U.S. Cl. 34/68

(57) ABSTRACT

The present invention relates to a laundry machine. The laundry machine includes a drum rotatably mounted in a cabinet, a hot air heater to heat air and supply hot air into the drum, a steam generator to supply steam into the drum, a water supply source to supply water to the steam generator, a pump to supply water in the water supply source to the steam generator, and a flow passage blocking prevention unit to prevent blocking of a flow passage connecting the pump and the steam generator.

This application claims the benefit of Korean Patent Application No. 10-2006-0128474, filed on Dec. 15, 2006, which is hereby incorporated by reference in its entirety as if fully set forth herein.

### BACKGROUND OF THE INVENTION

1. Field of the Invention

The present invention relates to a laundry machine, and more particularly, to a steam laundry dryer which has improved durability so as to operate normally even when an external temperature is low.

2. Discussion of the Related Art

Laundry dryers are typically electric appliances that dry washed laundry, mainly washed clothes, by using high temperature air. In general, a laundry dryer is configured of a drum, a driving source, heating means and a blower unit. Laundry is held in the drum, and the driving source drives the drum. The heating means heats air drawn into the drum. The blower unit sucks air into the drum, or discharges air outside the drum.

Laundry dryers may be categorized, based on a method of heating air, i.e., heating means, into electric type laundry dryers and gas type laundry dryers. In an electric type laundry dryer, air is heated by using electric resistance heat. In a gas type laundry dryer, air is heated by using heat generated from gas combustion. On the other hand, laundry dryers may be categorized into condensation type laundry dryers and exhaustion type laundry dryers. In a condensation type laundry dryer, air is heat exchanged with laundry in the drum and the damp air is circulated without being discharged outside the laundry dryer, to be heat-exchanged with external air at an auxiliary condenser. At this time, condensed water is generated and discharged outside. In an exhaustion type laundry dryer, air is heat-exchanged with laundry in the drum and the damp air is directly discharged outside the laundry dryer. Further, laundry dryers may be categorized, based on a method of loading laundry, into top loading type laundry dryers and front loading type laundry dryers. In a top loading type laundry dryer, laundry is loaded into the drum through a top of the laundry dryer. In a front loading type laundry dryer, laundry is loaded into the drum through a front of the laundry dryer.

However, the above conventional laundry dryers have the following problems.

Commonly, the washed and dehydrated laundry is loaded and dried in the laundry dryer. In view of a principle of water washing, the washed laundry has wrinkles, and the wrinkles are not removed during a drying process in the laundry dryer. As a result, the conventional laundry dryer has a shortcoming that a user should iron out the dried laundry to remove the wrinkles.

Moreover, in case that clothes besides the washed laundry are kept and used, the clothes may have wrinkles, crumples and fold marks (hereinafter, commonly referred to as “wrinkles”). Accordingly, there have been demands for development of devices capable of also easily removing the wrinkles generated by the common usage and keeping of the clothes.

### SUMMARY OF THE INVENTION

Accordingly, the present invention is directed to a steam laundry dryer that substantially obviates one or more problems due to limitations and disadvantages of the related art.

An object of the present invention is to provide a steam laundry dryer that can remove wrinkles of laundry.

Another object of the present invention is to provide a steam laundry dryer that can operate normally even when an external temperature is low.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a steam laundry dryer comprises: a drum rotatably mounted in a cabinet; a hot air heater to heat air and supply hot air into the drum; a steam generator to supply steam into the drum; a water supply source to supply water to the steam generator; a pump provided between the water supply source and the steam generator to selectively supply water in the water supply source to the steam generator; and a flow passage blocking prevention unit to prevent blocking of a hose connecting the pump and the steam generator due to freezing of water in the hose.

In the present invention, the steam generator is to generate steam to supply into the drum. Instead of the steam generator, other device can be used as long as the device is appropriate to supply fine droplets of water into the drum. For example, a spray nozzle can be used to supply fine droplets of water into the drum. The fine droplets of water supplied into the drum can be turned into steam by heat inside the drum. The spray nozzle is well known as a nozzle which turns water into fine droplets of water. The spray nozzle can be mounted at a location, like a rear support for the drum, appropriate to supply the fine droplets into the drum and connected to the water supply source by a hose.

According to the present invention, wrinkles generated on the laundry can be effectively removed, and the steam laundry dryer can operate normally even when an external temperature is low.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view illustrating a steam laundry dryer in accordance with an exemplary embodiment of the present invention;

FIG. 2 is a longitudinal-sectional view of FIG. 1;

FIG. 3 is a sectional view illustrating a steam generator shown in FIG. 1;

FIG. 4 is a schematic view illustrating a steam generator of a steam laundry dryer in accordance with another exemplary embodiment of the present invention;

FIG. 5 is an exploded perspective view illustrating an example of a water supply source shown in FIG. 4;

FIG. 6 is a sectional view schematically illustrating an example of a pump shown in FIG. 4;

FIG. 7 is a partial sectional view illustrating a first embodiment of a flow passage blocking prevention unit to prevent blockage of a flow passage connecting the pump and the steam generator in FIG. 4;

FIG. 8 is a sectional view illustrating a second embodiment of a flow passage blocking prevention unit to prevent blockage of a flow passage connecting the pump and the steam generator in FIG. 4 (for convenience of explanation, FIG. 8 is a sectional view taken along line VIII-VIII in FIG. 7);

FIG. 9 is a perspective view illustrating a third embodiment of a flow passage blocking prevention unit to prevent blockage of a flow passage connecting the pump and the steam generator in FIG. 4;

FIG. 10 is a schematic view illustrating a fourth embodiment of a flow passage blocking prevention unit to prevent blockage of a flow passage connecting the pump and the steam generator in FIG. 4;

FIG. 11 is a schematic view illustrating a fifth embodiment of a flow passage blocking prevention unit to prevent blockage of a flow passage connecting the pump and the steam generator in FIG. 4;

FIG. 12 is a schematic view illustrating a sixth embodiment of a flow passage blocking prevention unit to prevent blockage of a flow passage connecting the pump and the steam generator in FIG. 4;

FIG. 13 is a schematic view illustrating a state of mounting a regulating member in the flow passage to selectively drive the pump when water in the steam generator is discharged by the pump in FIG. 4;

FIGS. 14 and 15 are schematic views illustrating a state in which the regulating member shown in FIG. 13 operates according to a temperature of water flowing along the flow passage; and

FIG. 16 is a perspective view illustrating a state of mounting components shown in FIG. 4.

### DETAILED DESCRIPTION OF THE INVENTION

Reference will now be made in detail to the preferred embodiments of the present invention associated with a steam laundry dryer, examples of which are illustrated in the accompanying drawings. Wherever possible, the same reference numbers will be used throughout the drawings to refer to the same or like parts. For convenience of explanation of a steam laundry dryer according to the present invention, a top loading type, electric type and condensation type laundry dryer will be exemplified. However, the present invention is not limited to the above example, and also can be applied to a front loading type, gas type and condensation type laundry dryer.

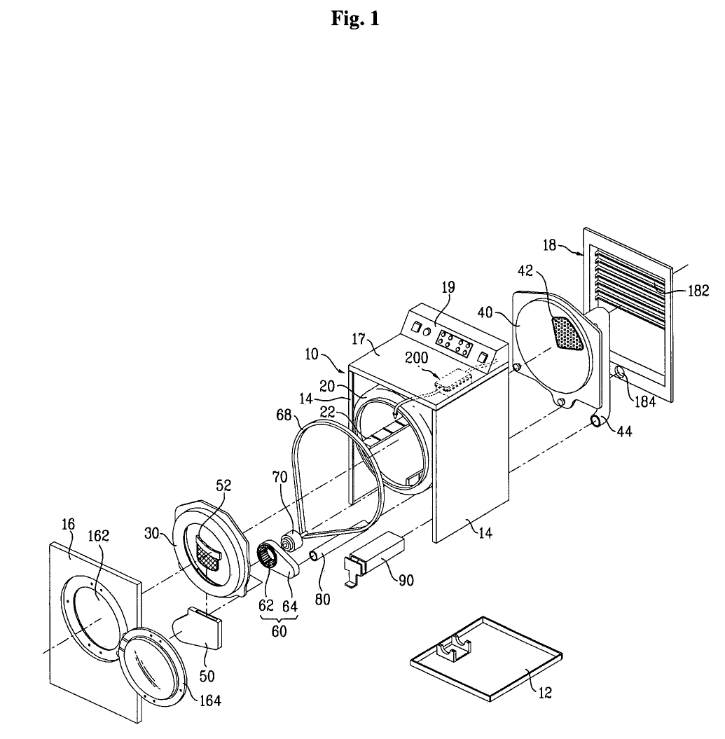

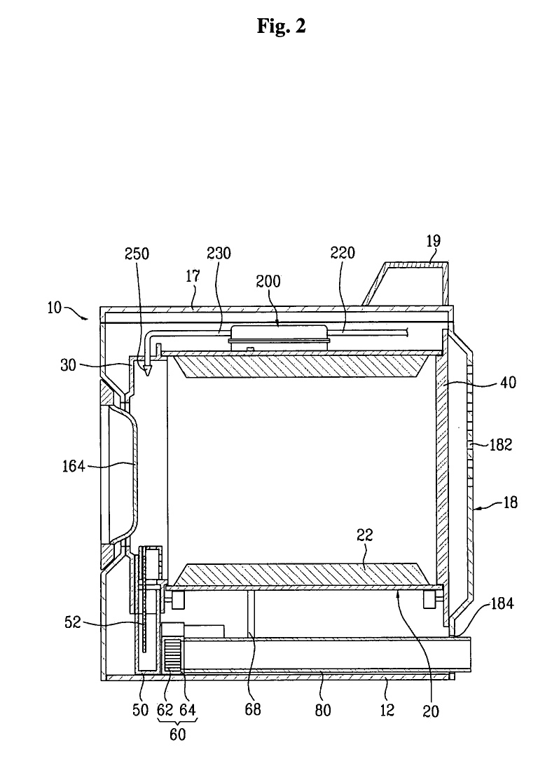

FIG. 1 is an exploded perspective view illustrating a steam laundry dryer in accordance with an exemplary embodiment of the present invention, and FIG. 2 is a longitudinal-sectional view of FIG. 1.

A steam laundry dryer according to an exemplary embodiment of the present invention will now be described with reference to FIGS. 1 and 2.

A cabinet 10 defines an exterior appearance of the steam laundry dryer according to the present invention, and houses components described below. Inside the cabinet 10 are mounted a rotatable drum 20, and a motor 70 and a belt 68 to drive the drum 20. A heater 90 (hereinafter, referred to as “hot air heater”) is mounted in a predetermined portion of the cabinet 10 to create air of a high temperature (hereinafter, referred to as “hot air”) by heating the air. A hot air supply duct 44 is mounted in a predetermined portion of the cabinet 10 to supply the hot air generated from the hot air heater 90 into the drum 20. Also, there are provided an exhaustion duct 80 and a blower unit 60 in the cabinet 10. The damp air heat-exchanged with the laundry in the drum 20 is discharged outside the drum 20 through the exhaustion duct 80, and the damp air is sucked by the blower unit 60. A steam generator 200 is mounted in a predetermined portion of the cabinet 10 to generate steam of a high temperature.

For convenience of explanation, this embodiment shows and describes an indirect drive type such that the drum 20 is rotated by the motor 70 and the belt 68, however the present invention is not limited thereto. In other words, the present invention also can be applied to a direct drive type such that the drum 20 is directly rotated by directly connecting the motor to a rear surface of the drum 20.

The aforesaid components will now be explained in detail.

The cabinet 10 defining the exterior appearance of the laundry dryer includes a base 12 forming a bottom surface, a pair of side covers 14 vertically mounted to the base 12, a front cover 16 mounted to front surfaces of the side covers 14, a rear cover 18 mounted to rear surfaces of the side covers 14, and a top cover 17 mounted to top surfaces of the side covers 14. A control panel 19 having various operational switches is positioned on the top cover 17 or the front cover 16, and a door 164 is coupled to the front cover 16. An air inlet 182 and an air outlet 184 are provided at the rear cover 18. External air is drawn through the air inlet 182, and the air in the drum 20 is discharged outside through the air outlet 184 that is a final path to the outside.

An inner space of the drum 20 is employed as a drying chamber for drying the laundry. It is preferred that a lifter 22 is installed in the drum 20 to lift and drop the laundry, so that the laundry is turned over to enhance drying efficiency.

A front supporter 30 and a rear supporter 40 are provided between the drum 20 and the cabinet 10. More particularly, the front supporter 30 is provided between the drum 20 and the front cover 16, and the rear supporter 40 is provided between the drum 20 and the rear cover 18. The drum 20 is rotatably mounted between the front supporter 30 and the rear supporter 40, and sealing members (not shown) for preventing water leakage are provided between the front supporter 30 and the drum 20 and between the drum 20 and the rear supporter 40. The front supporter 30 and the rear supporter 40 shield a front surface and a rear surface of the drum 20, respectively, to form the drying chamber and support a front end and a rear end of the drum 20.

An opening is formed at the front supporter 30 to communicate the drum 20 with the outside of the laundry dryer. The opening is selectively opened and closed by the door 164. A lint duct 50, through which the air in the drum 20 flows outside, is connected to the front supporter 30, and a lint filter 52 is installed at the lint duct 50.

A portion of the blower unit 60 is connected to the lint duct 50, and an opposite portion of the blower unit 60 is connected to the exhaustion duct 80. The exhaustion duct 80 is in communication with the air outlet 184 provided at the rear cover 18.

Accordingly, if the blower unit 60 operates, the air in the drum 20 flows through the lint duct 50, the exhaustion duct 80 and the air outlet 184 in order, and is discharged outside. At this time, foreign substances including lint are filtered by the lint filter 52. The blower unit 60 typically consists of a blower 62 and a blower housing 64. The blower 62 is commonly connected to the motor 70 for driving the drum 20.

An opening portion 42 including a plurality of through-holes is formed at the rear supporter 40, and the hot air supply duct 44 is connected to the opening portion 42. The hot air supply duct 44 is in communication with the drum 20, and is employed as a path for supplying hot air into the drum 20. For this, the hot air heater 90 is mounted in a predetermined portion of the hot air supply duct 44.

The steam generator 200 is mounted in a predetermined portion of the cabinet 10 to generate steam and supply the steam into the drum 20.

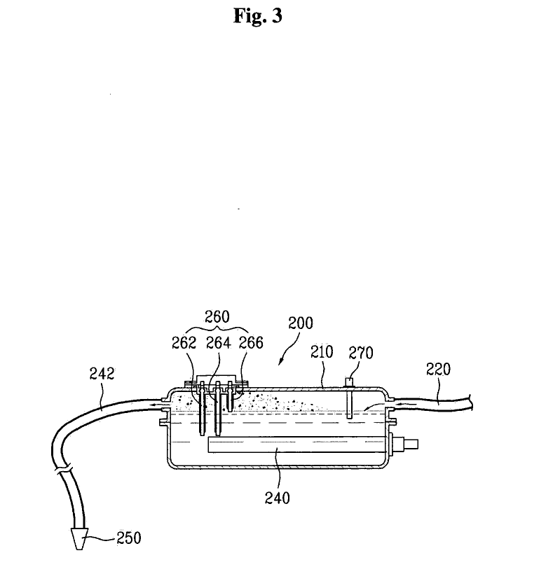

FIG. 3 is a sectional view illustrating the steam generator shown in FIG. 1. The steam generator 200 will now be explained in detail with reference to FIG. 3.

The steam generator 200 includes a water tank 210 to store water therein, a heater 240 mounted in the water tank 210, a water level sensor 260 to detect a water level in the steam generator 200, and a temperature sensor 270 to detect a temperature of the steam generator 200. The water level sensor 260 includes a common electrode 262, a low water level electrode 264 and a high water level electrode 266. A high water level is sensed based on whether an electric current is applied between the common electrode 262 and the high water level electrode 266, and a low water level is sensed based on whether an electric current is applied between the common electrode 262 and the low water level electrode 264.

A water supply hose 220 is connected to a portion of the steam generator 200 to supply water, and a steam hose 242 is connected to an opposite portion of the steam generator 200 to discharge steam. It is preferred that a nozzle 250 having a predetermined shape is provided at a front end of the steam hose 242. An end of the water supply hose 220 is typically connected to an external water supply source such as a water tap. The front end of the steam hose 242 or the nozzle 250, that is, a steam outlet is positioned at a predetermined portion of the drum 20 to spray steam into the drum 20.

Although this embodiment shows and describes the steam generator 200 in which the heater 240 heats the water in the water tank 210 to generate steam (hereinafter, referred to as “tank heating type steam generator” for convenience of explanation), the present invention is not limited thereto. In other words, any device capable of generating steam may be used as the steam generator in the present invention. For example, a steam generator in which a heater is directly installed around a water supply hose to heat the water flowing through the water supply hose, without storing water in a predetermined space, (hereinafter, referred to as “pipe heating type steam generator” for convenience of explanation) may be applicable to the present invention.

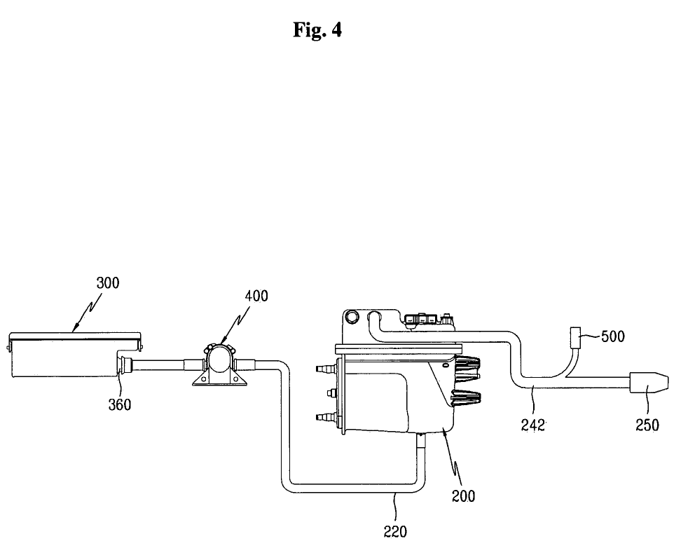

FIG. 4 is a schematic view illustrating a steam generator of a steam laundry dryer in accordance with another exemplary embodiment of the present invention. A steam laundry dryer according to another embodiment of the present invention will now be described with reference to FIG. 4.

In this embodiment, a water supply source for supplying water to the steam generator 200 is detachably mounted. The water supply source may be configured as a water tap as described in the previous embodiment. However, in such a case, the installation becomes complicated. This is because the laundry dryer does not commonly use water, if the water tap is used as the water supply source, various devices annexed thereto should be additionally installed. Accordingly, this embodiment using a detachable water supply source 300 is very convenient in use. In other words, the water supply source 300 is detached from the laundry dryer to be filled with water, and then the water supply source 300 filled with water is connected to a water supply passage of the steam generator 200, i.e., the water supply hose 220.

It is preferred that a pump 400 is provided between the water supply source 300 and the steam generator 200. More preferably, the pump 400 can rotate in a forward direction and a reverse direction, so as to supply water into the steam generator 200 or collect residual water in the steam generator 200 as needed.

It also may be possible to supply water into the steam generator 200 by using a difference in water column heights between the water supply source 300 and the steam generator 200, without using the pump 400. However, because the components of the steam laundry dryer are typically standardized and designed compactly, a structural space is absolutely small. Therefore, if sizes of the components of the conventional laundry dryer are not changed, the water supply using the difference in water column heights is practically impossible. As a result, it is very useful to use the compact pump 400, because the steam generator 200 can be installed without changing sizes of the components of the conventional laundry dryer. Here, the reason for collecting residual water in the steam generator 200 is that if the steam generator 200 is not used for a long period, the heater may be damaged by the residual water or rotten water may be used in the following operation.

While the previous embodiment is configured such that the water supply and the steam exhaustion are achieved through the upper portion of the steam generator 200, this embodiment is configured such that water is supplied through the lower portion of the steam generator 200 and steam is exhausted through the upper portion of the steam generator 200. Such a configuration of this embodiment is effective to collect residual water in the steam generator 200. Also, it is preferred that a safety valve 500 is provided at a steam passage for discharging steam from the steam generator 200, i.e., the steam hose 242.

Hereinafter, the respective components will be explained in detail with reference to the drawings.

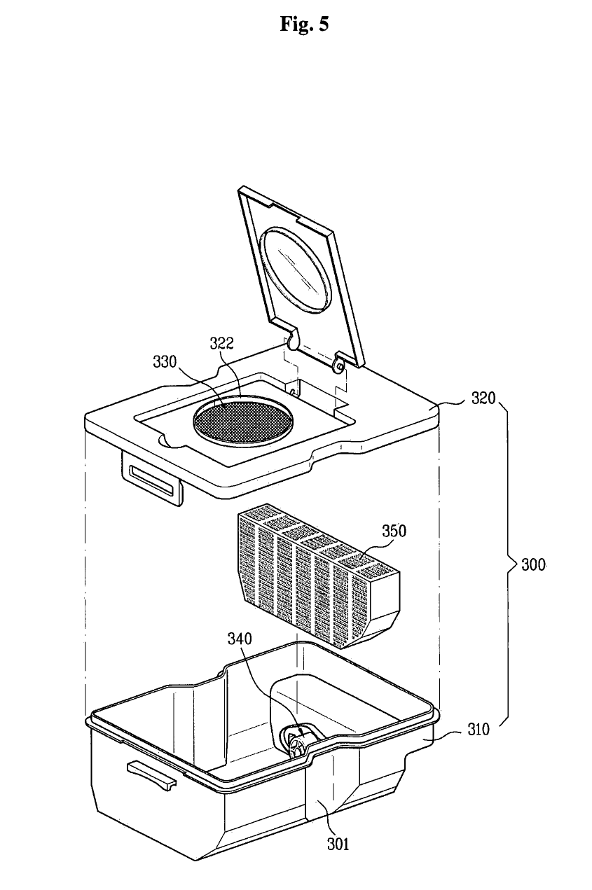

First, the detachable water supply source 300 (hereinafter, referred to as “cartridge” for convenience of explanation) will be explained in detail with reference to FIG. 5.

The cartridge 300 includes a lower housing 310 to substantially store water therein, and an upper housing 320 detachably coupled to the lower housing 310. If the cartridge 300 is composed by the lower housing 310 and the upper housing 320, it is easy to clean out dirt of water in the cartridge 300 and to dismantle filters 330 and 340 and a water softening member 350 (which will be described later) to clean and reuse them.

It is preferred that a first filter 330 is mounted to the upper housing 320. In other words, the first filter 330 is mounted to a water inlet 322 of the upper housing 320, to firstly filter the water supplied into the cartridge 300.

An opening/closing member 360 (refer to FIG. 4) is provided at the lower housing 310 to selectively supply water in the cartridge 300 to the outside. When the cartridge 300 is detached, the opening/closing member 360 blocks the water from being discharged outside the cartridge 300. When the cartridge 300 is installed, the opening/closing member 360 permits the water to be discharged outside the cartridge 300. It is also preferred that a second filter 340 for filtering water is connected to the opening/closing member 360. It is more preferred that the second filter 340 is detachably provided.

By using the first filter 330 and the second filter 340, impurities, such as micro dust, contained in water can be filtered off twice. It is preferable to use the first filter 330 having about 50 mesh nets and the second filter 340 having about 60 mesh nets. Here, the 50 mesh nets refer to that the number of mesh per a predetermined area is 50. Accordingly, since a size of an air hole composing the mesh of the first filter 330 is larger than a size of an air hole composing the mesh of the second filter 340, the relatively large foreign substances are firstly filtered off by the first filter 330, and the relatively small foreign substances are secondarily filtered off by the second filter 340.

It is also preferred that a water softening member 350 for softening water is provided in the cartridge 300. It is more preferred that the water softening member 350 is detachably provided.

The reason for using the water softening member 350 is as follows. If hardness of water supplied into the steam generator 200 is high, when calcium hydrogen carbonate (Ca(HCO3)2) dissolved in water is heated, lime (calcium carbobate (CaCO3)) is educed, which may cause corrosion of the heater. Especially, such a phenomenon is accelerated in the European and American continents in which hard water having high hardness is used. Accordingly, it is preferable to prevent the eduction of the lime by using ion exchange resin to remove calcium and magnesium ions in advance. Because performance of the ion exchange resin is deteriorated as the water softening process is performed, the ion exchange resin is regenerated by salt (NaCl) and reused. The water softening process by the ion exchange resin is represented as follows: 2(R—SONa)+Ca2<->(R—SO)Ca+2Na. The regenerating process is represented as follows: (R—SO)Ca+2NaCl<->2(R—SONa)+CaCl.

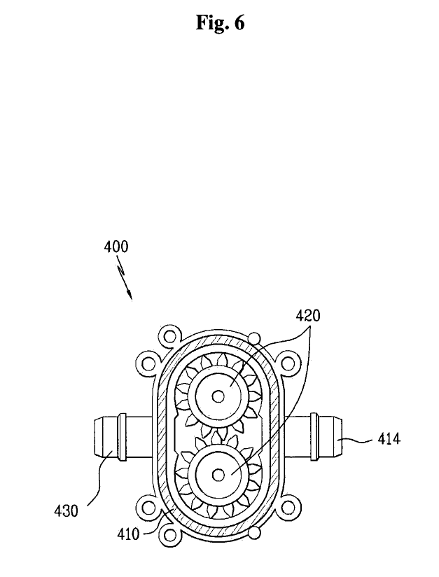

FIG. 6 is a sectional view schematically illustrating an example of a pump according to the present invention.

Referring to FIG. 6, the pump 400 is employed to selectively supply water into the steam generator 200. It is preferred that the pump 400 can rotate in a forward direction and a reverse direction, so as to supply water into the steam generator 200 or collect water from the steam generator 200 as needed.

The pump 400 may be configured as a gear type pump, a pulsating type pump, or a diaphragm type pump. The pulsating type pump and the diaphragm type pump can control the flow of fluid in a forward direction and a reverse direction by changing polarities of a circuit momentarily as needed.

FIG. 6 illustrates a gear type pump as an example of the pump 400. The gear type pump 400 includes a case 410 and a pair of gears 420 provided in the case 410. The case 410 is provided with an inlet port 430 and an outlet port 414. According to a rotational direction of the gears 420, the water flows from the inlet port 430 to the outlet port 414 or from the outlet port 414 to the inlet port 430.

Referring again to FIG. 4, the pump 400 and the steam generator 200 are connected to each other by the water supply hose 220 forming a flow passage through which water flows. The water from the pump 400 is supplied to the steam generator 200 through the water supply hose 220. As described above, it is preferred that the water is supplied through the lower portion of the steam generator 200 so as to easily collect the residual water in the steam generator 200.

To this end, as shown in FIG. 4, the water supply hose 220 connecting the pump 400 and the steam generator 200 has a substantially “U” shape. However, in such a configuration, a small amount of water flows to the water supply hose 220 from the pump 400 even when the pump 400 does not operate, and remains in the U-shaped water supply hose 220. If an external temperature drops greatly, for example, in winter or in the polar regions, the residual water in the water supply hose 220 is frozen, and blocks the water supply hose 220, so that the water cannot be supplied to the steam generator 200. To cope with this problem, the steam laundry dryer according to the present invention includes a flow passage blocking prevention unit to prevent blockage of the flow passage connected to the steam generator 200 due to decrease in an external temperature. Hereinafter, the flow passage blocking prevention unit will be explained in detail.

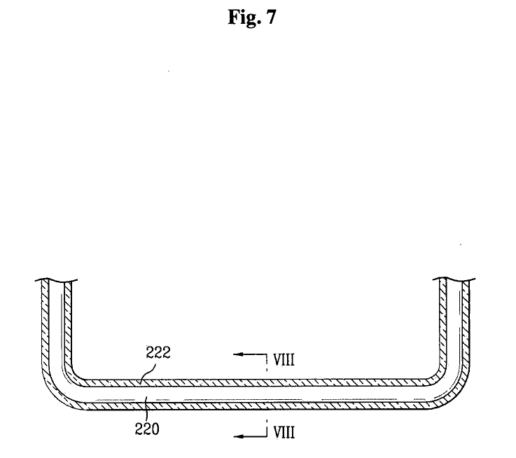

FIGS. 7 to 10 are schematic views illustrating exemplary embodiments of the flow passage blocking prevention unit to prevent that the water supply hose 220 is blocked and the water cannot be supplied when an external temperature drops. The respective exemplary embodiments of the flow passage blocking prevention unit will now be explained with reference to the drawings.

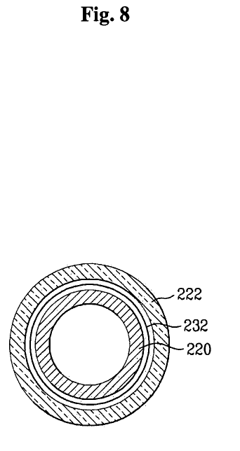

As shown in FIG. 7, a first embodiment of the flow passage blocking prevention unit includes a heat insulating member 222 which surrounds the water supply hose 220. The heat insulating member 222 is made of a material having excellent heat insulating properties, and preferably, is made by an injection forming method. By the heat insulating member 222 surrounding the water supply hose 220, heat cannot be dissipated outside, and also external cool air cannot permeate into the water supply hose 220. Accordingly, even when an external temperature drops, the residual water in the water supply hose 220 is not frozen. In addition to the heat insulating member 222 surrounding the water supply hose 220, a heater may be provided as shown in FIG. 8. If the water supply hose 220 is heated by the heater, the freezing of water in the water supply hose 220 can be more effectively prevented, which will now be explained with reference to FIG. 8.

FIG. 8 is a sectional view illustrating a second embodiment of the flow passage blocking prevention unit, which is taken along line VIII-VIII in FIG. 7 for convenience of explanation. When compared to the first embodiment, this embodiment further includes a heater.

In this embodiment, the water supply hose 220 is heated by a heater 232, and the heater 232 is surrounded by the heat insulating member 222. Since the heater 232 heats the water supply hose 220 and at the same time the heat insulating member 222 prevents external cool air from permeating into the water supply hose 220, the freezing of water in the water supply hose 220 can be more effectively prevented.

Preferably, the heater 232 is positioned between the hose 220 and the heat insulating member 222 so that the heater 232 is not directly contacted with water, thereby preventing deformation or breakage of the heater 232 due to lime and other remnants which may be included in water. It is preferred that the heater 232 is configured as a film heater which can be easily installed, however the heater 232 is not restricted thereto.

Although it is not illustrated in the drawings, the steam laundry dryer according to the present invention may further include a temperature sensor (not shown) to measure an external temperature, so as to control the operation of the heater 232 according to the measured results of the temperature sensor.

Describing in detail, the external temperature measured by the temperature sensor is transmitted to a controller (not shown) of the steam laundry dryer. If the measured external temperature is more than a predetermined reference temperature (e.g., 0° C.), the controller does not drive the heater 232. If the measured external temperature is less than the predetermined reference temperature (e.g., 0° C.), the controller drives the heater 232 to prevent the freezing of water in the water supply hose 220. Here, the above reference temperature can be changed adequately according to regions in which the steam laundry dryer is installed, climate or weather.

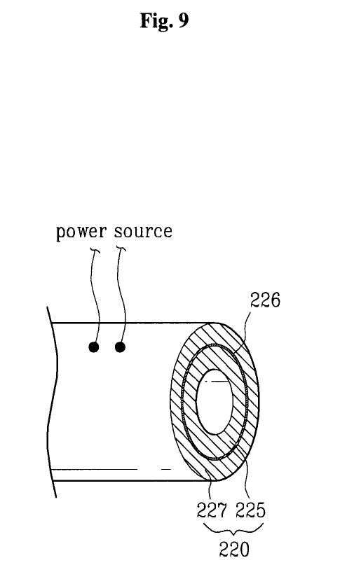

FIG. 9 is a sectional view illustrating a third embodiment of the flow passage blocking prevention unit. Referring to FIG. 9, when compared to the second embodiment, this embodiment does not include a heat insulating member. In other words, although the heat insulating member is not provided at the water supply hose, if a heater is arranged along the water supply hose, the freezing of water in the water supply hose can be sufficiently prevented by the heater.

The flow passage blocking prevention unit of this embodiment includes a heater 226 arranged along the water supply hose 220 without being equipped with a heat insulating member. Preferably, the heater 226 is embedded in the hose 220, that is, is positioned between an inner layer 225 and an outer layer 227 of the hose 220 so that the heater 226 is not directly contacted with water, thereby preventing deformation or breakage of the heater 226 due to lime and other remnants which may be included in water. It is preferred that the heater 226 is configured as a film heater which can be easily installed, however the heater 226 is not restricted thereto.

Similarly to the previous embodiment shown in FIG. 8, this embodiment may further include a temperature sensor (not shown), so as to control the operation of the heater 226 according to the measured results of the temperature sensor. Since the temperature sensor and the control method using the temperature sensor are similar to the previous embodiment, the detailed explanation thereof will be omitted.

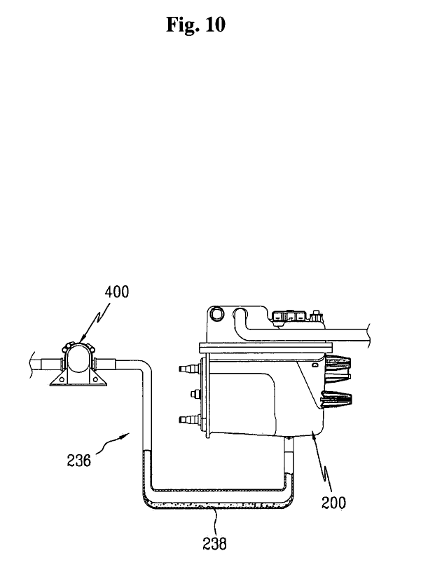

FIG. 10 is a schematic view illustrating a fourth embodiment of the flow passage blocking prevention unit.

Referring to FIG. 10, the flow passage blocking prevention unit of this embodiment includes an expanded tube part 238 provided at a water supply hose 236 connecting the pump 400 and the steam generator 200.

The expanded tube part 238 has a cross-sectional area larger than the water supply hose 236. Preferably, the expanded tube part 238 is provided in the middle of the U-shaped water supply hose 236. Although the residual water in the water supply hose 236 is frozen by the decrease in an external temperature, the blockage of the water supply hose 236 can be prevented by the expanded tube part 238. Describing in detail, although the residual water in the water supply hose 236 is frozen, as shown in FIG. 10, the water is frozen just on a bottom of the expanded tube part 238 having the cross-sectional area larger than the water supply hose 236, thereby preventing the whole sectional area of the water supply hose 236 from being blocked.

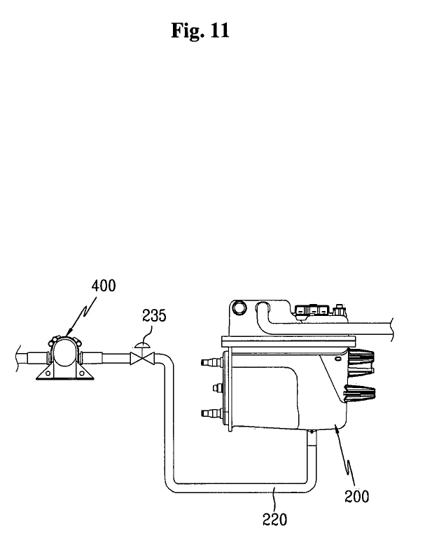

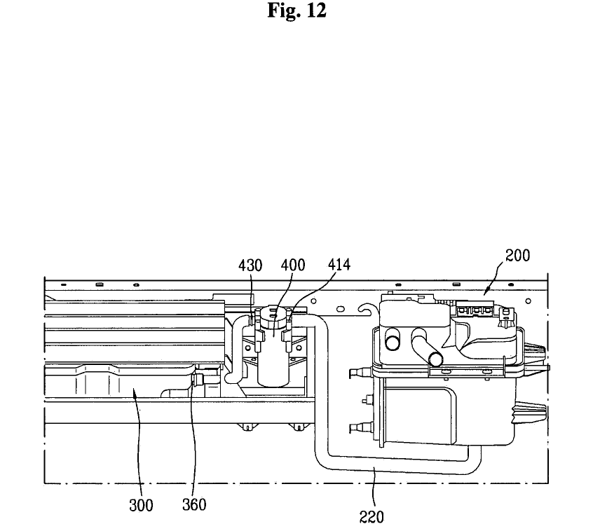

The above-described embodiments relate to a structure capable of preventing the freezing of the residual water in the water supply hose (flow passage) or preventing the blockage of the water supply hose although the residual water is frozen. Instead of the above flow passage blocking prevention structures, the present invention can be constituted so as to prevent water from remaining in the flow passage. FIGS. 11 and 12 illustrate embodiments capable of preventing the blockage of the flow passage by preventing water from remaining in the flow passage. Such embodiments will now be described with reference to the drawings.

FIG. 11 is a schematic view illustrating a fifth embodiment of the flow passage blocking prevention unit.

Referring to FIG. 11, the flow passage blocking prevention unit of this embodiment includes a valve 235 mounted in the water supply hose 220.

As described above, a gear type pump can be employed as the pump 400 in the present invention, however the pump 400 is not restricted thereto. The gear type pump supplies water by the rotation of a pair of gears 420 (refer to FIG. 6). Even when the gear type pump does not operate, a small amount of water may leak through a micro gap between the gears 420. The leaking water may gather in the water supply hose 220, and may be frozen by the decrease in an external temperature, thereby causing the blockage of the water supply hose 220.

To cope with this problem, the valve 235 is mounted in the water supply hose 220 so as to prevent the water leaking from the pump 400 from remaining in the water supply hose 220. It is preferred that the valve 235 is positioned as close to the pump 400 as possible. This is to minimize the amount of water remaining in the water supply hose 220 after leaking from the pump 400.

FIG. 12 is a schematic view illustrating a sixth embodiment of the flow passage blocking prevention unit.

Referring to FIG. 12, in the flow passage blocking prevention unit of this embodiment, the pump 400 is mounted such that the inlet port 430 of the pump 400 is positioned higher than the opening/closing member 360 through which the water in the cartridge 300 is discharged.

Describing in detail, if the inlet port 430 of the pump 400 is positioned at a height equal to the opening/closing member 360 through which the water in the cartridge 300 is discharged, a small amount of water leaks from the pump 400 and remains in the water supply hose 220 even when the pump 400 does not operate. If an external temperature drops, the residual water in the water supply hose 220 is frozen to block the water supply hose 220, so that the water cannot be supplied to the steam generator 200.

To cope with this problem, this embodiment is constituted such that the inlet port 430 of the pump 400, through which water is supplied into the pump 400, is positioned higher than the opening/closing member 360 through which the water in the cartridge 300 is discharged. By such a constitution, even when the pump 400 does not operate, the water leakage from the pump 400 can be prevented by a water head difference between the opening/closing member 360 and the inlet port 430. A non-described reference numeral 414 in FIG. 12 refers to an outlet port through which the water in the pump 400 is discharged.

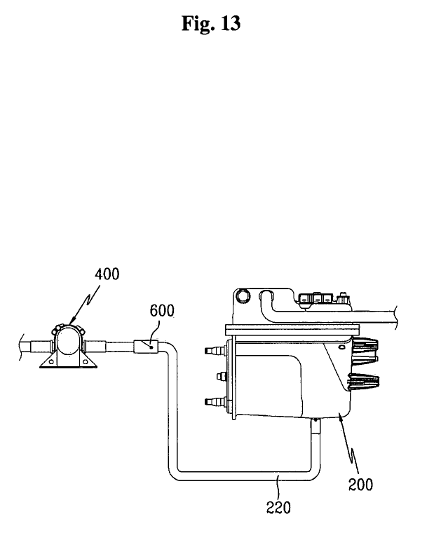

FIG. 13 is a schematic view illustrating an example of a regulating member to drive the pump according to a temperature of the water flowing along the flow passage when the pump rotates in a reverse direction to discharge the residual water in the steam generator.

Describing in detail, a regulating member 600 of this embodiment measures a temperature of the water flowing along the water supply hose 220 when the pump 400 rotates in a reverse direction to discharge the residual water in the steam generator 200 outside. If the measured temperature is more than a predetermined temperature, the regulating member 600 stops the operation of the pump 400 to prevent the breakage of the pump 400 due to the water of a high temperature.

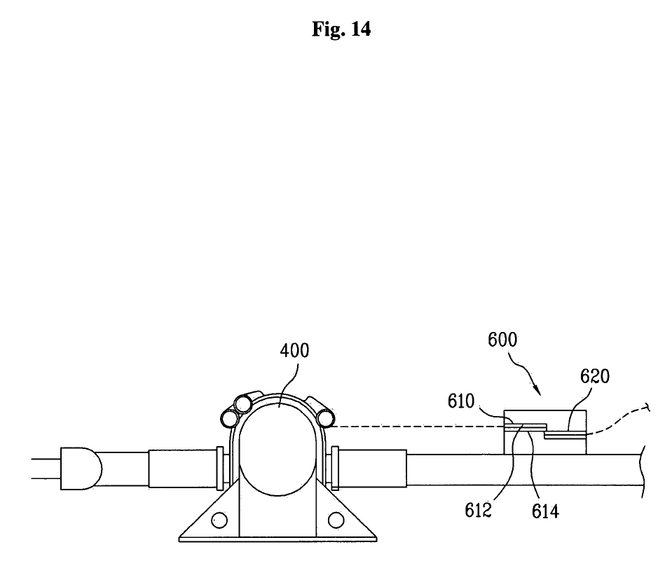

Referring to FIG. 13, the regulating member 600 is mounted to the water supply hose 220 connecting the pump 400 and the steam generator 200. The concrete constitution of the regulating member 600 will now be described with reference to FIG. 14.

The regulating member 600 is configured as a bimetal sensor 610 which is mounted along the water supply hose 220. The bimetal sensor 610 is selectively contacted with a power supply 620 according to a temperature of water so as to apply the power or interrupt the power. The bimetal sensor 610 includes two kinds of metals 612 and 614 having different thermal expansion coefficients, and is bent by being heated by the temperature of water.

As shown in FIG. 14, if the temperature of water flowing along the water supply hose 220 is less than a predetermined temperature (e.g., 80° C.), because there is no large difference between the expanding degrees of the two metals 612 and 614, the bimetal sensor 610 is not bent, and is kept in a condition of being contacted with the power supply 620. Accordingly, the pump 400 is driven successively by receiving power.

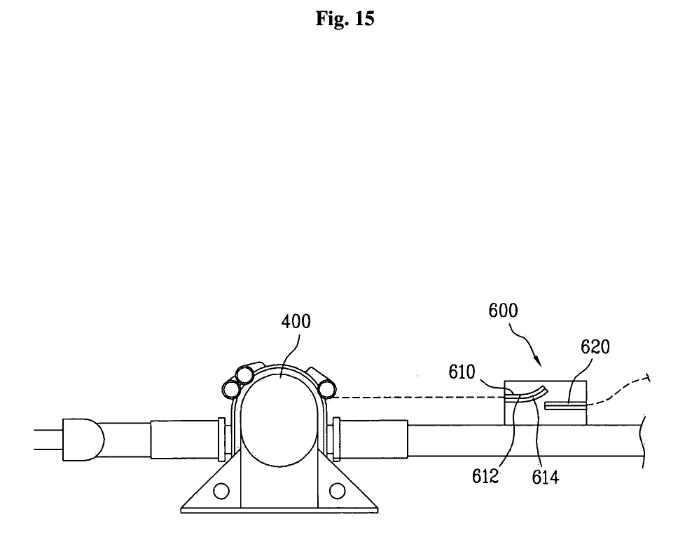

On the other hand, if the temperature of water flowing along the water supply hose 220 is more than the predetermined temperature (e.g., 80° C.), there occurs a difference between the expanding degrees of the two metals 612 and 614. As shown in FIG. 15, the bimetal sensor 610 is bent overall toward the metal 612 having the relatively small thermal expansion coefficient (upper metal in the drawing), and accordingly the bimetal sensor 610 is separated from the power supply 620. As a result, the power is not applied to the pump 400, and the operation of the pump 400 is stopped, thereby preventing the breakage of the pump 400 due to the water of a high temperature.

After the power is interrupted by the bimetal sensor 610, if the temperature of water drops below the predetermined temperature, the bimetal sensor 610 gets straightened out again as shown in FIG. 14. Accordingly, the power is applied again to the pump 400 to drive the same.

This embodiment is provided with the regulating member 600 so as to prevent the breakage of the pump 400 due to the water of a high temperature when the pump 400 rotates in the reverse direction, however the present invention is not restricted thereto. For example, the operation of the pump 400 may be controlled by the controller by using the temperature sensor 270 which measures a temperature of the steam generator 200. In other words, a temperature of the water pumped from the pump 400 is measured by the temperature sensor 270, and if the measured temperature of water is more than a predetermined temperature, the controller stops the operation of the pump 400.

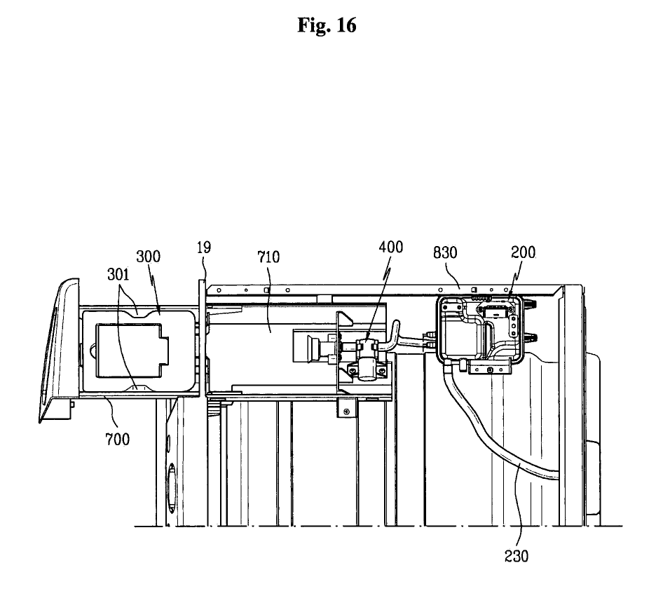

The installation of the steam generator and other components of a steam line according to the present invention will now be explained with reference to FIG. 16.

A drawer type container 700 (hereinafter, referred to as “drawer”) is drawably inserted into a predetermined portion of the steam laundry dryer. Preferably, the cartridge 300 is mounted in the drawer 700. In other words, it is preferable to mount the cartridge 300 in the drawer 700 and to indirectly connect/disconnect the cartridge 300 to/from the pump 400 by inserting/drawing the drawer 700, rather than to directly connect the cartridge 300 to the pump 400.

It is preferred that the drawer 700 is provided at the front surface of the steam laundry dryer, e.g., the control panel 19. A supporter 820 is mounted at the rear of the control panel 19. Particularly, the supporter 820 is mounted substantially parallel with a top frame 830, and a drawer guide 710 is mounted to the supporter 820 and the top frame 830 to guide and support the drawer 700. Although it is not illustrated in the drawings, it is preferable to provide a top guide at a portion of an upper portion of the drawer guide 710.

The upper portion and one side surface (at a direction of the front surface of the steam laundry dryer) of the drawer guide 710 are opened. The drawer 700 is inserted and drawn through the front opening portion of the steam laundry dryer, and the pump 400 is provided at an upper surface of the other side of the drawer guide 710.

As described above, it is preferable to mount the drawer 700 to the front surface of the laundry dryer from an aspect of convenience in use. FIG. 16 illustrates the laundry dryer in which the control panel 19 is mounted to the front cover, and the drawer 700 is inserted into and drawn out from the control panel 19. However, the present invention is not restricted thereto. For example, when the control panel is mounted to a top cover as shown in FIG. 1, it is possible to directly mount the drawer 700 to the front cover.

When it is designed such that the cartridge 300 is mounted in the drawer 700, it is preferred that at least both side surfaces of the cartridge 300 are shaped corresponding to both side surfaces of the drawer 700, so that the cartridge 300 is tightly coupled to the drawer 700. It is also preferred that both the side surfaces of the cartridge 300 is formed with concave portions 301 to facilitate the mounting/demounting of the cartridge 300.

Hereinafter, a process of supplying water into the cartridge 300 will be explained with reference to FIG. 16.

If a user draws out the drawer 700, the cartridge 300 is also drawn out therewith. Then, the user dismantles the cartridge 300 from the drawer 700. Water is supplied into the cartridge 300 through the water inlet 322 so that the cartridge 300 is filled with the water. The cartridge 300 filled with the water is mounted again in the drawer 700, and the drawer 700 is pushed in. The opening/closing member 360 of the cartridge 300 is automatically connected to the pump 400, and the water in the cartridge 300 flows to the pump 400.

When the operation of the steam laundry dryer is completed, the cartridge 300 can be removed from the drawer 700. Since the cartridge 300 is composed of the upper housing 320 and the lower housing 310, it is easy to clean the removed cartridge 300.

Experimental results by this inventor show that the steam laundry dryer according to the present invention has an effect of removing and preventing wrinkles of laundry, although there is a difference according to the kinds of laundry, e.g., the kinds of cloths, hygroscopic properties, and the like. The object to be dried by the steam laundry dryer is generally the laundry dehydrated by a washing machine, however this is not restricted thereto. For example, the steam laundry dryer according to the present invention can remove wrinkles of the clothes that a user has worn for one day or more, i.e., the already dried clothes having few wrinkles. In other words, the steam laundry dryer according to the present invention also can be used as a kind of wrinkle-removing apparatus.

The steam laundry dryer according to the present invention may have the following advantageous effects.

First, wrinkles or crumples generated on the dried laundry can be effectively prevented or removed. Further, sterilization and deodorization of the dried laundry can be achieved.

Second, it can be prevented that water cannot be supplied to the steam generator by the freezing of water in the steam laundry dryer due to the decrease in an external temperature.

Third, the pump can be prevented from being broken due to water of a high temperature in the steam laundry dryer by measuring a temperature of water when collecting the residual water in the steam laundry dryer.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A laundry machine comprising:
a drum rotatably mounted in a cabinet;
a hot air heater to heat air for supplying hot air into the drum;
a steam generator to supply steam into the drum; and
a flow passage blocking prevention unit to prevent blocking of a flow passage for supplying water to the steam generator due to freezing of water.

2. The laundry machine according to claim 1, wherein the flow passage blocking prevention unit comprises a heat insulating member surrounding the flow passage.

3. The laundry machine according to claim 2, wherein the flow passage blocking prevention unit further includes a heater to heat the flow passage.

4. The laundry machine according to claim 3, wherein the heater is configured as a film heater.

5. The laundry machine according to claim 3, wherein the heater is provided between the flow passage and the heat insulating member.

6. The laundry machine according to claim 3, further comprising:
a temperature sensor to measure an external temperature; and
a controller to drive the heater based on a measured temperature of the temperature sensor.

7. The laundry machine according to claim 1, wherein the flow passage blocking prevention unit comprises a heater to heat the flow passage.

8. The laundry machine according to claim 7, wherein the heater is embedded in a hose forming the flow passage so as not to be directly contacted with by water flowing along the hose.

9. The laundry machine according to claim 7, further comprising:
a temperature sensor to measure an external temperature; and
a controller to drive the heater based on a measured temperature of the temperature sensor.

10. The laundry machine according to claim 1, wherein the flow passage blocking prevention unit comprises an expanded tube part provided at a predetermined portion of the flow passage.

11. The laundry machine according to claim 1, wherein the flow passage blocking prevention unit comprises a valve to selectively pass water to flow along the flow passage.

12. The laundry machine according to claim 11, wherein the valve is mounted in the flow passage, adjacent to the pump.

13. The laundry machine according to claim 1, wherein the flow passage blocking prevention unit includes a connecting structure between a water supply source and the pump mounted such that an inlet port of the pump is positioned higher than a water discharging point of the water supply source.

14. A laundry machine comprising:
a drum rotatably mounted in a cabinet;
a hot air heater to heat air for supplying hot air into the drum;
a steam generator to supply steam into the drum;
a water supply source to supply water to the steam generator; and
a pump to pump water in the steam generator to the water supply source, the pump being selectively driven based on a temperature of water in the steam generator or a flow passage for supplying water from the water supply source to the steam generator.

15. The laundry machine according to claim 14, further comprising:
a regulating member to selectively drive the pump by measuring a temperature of water in the flow passage.

16. The laundry machine according to claim 15, wherein when a temperature of water flowing along the flow passage is more than a predetermined temperature, the regulating member stops operation of the pump.

17. The laundry machine according to claim 15, wherein the regulating member is configured as a bimetal sensor.
